(19) United States
(12) Patent Application Publication
(10) Pub. No.: US 2026/0140558 A1
(43) Pub. Date: May 21, 2026

(54) POWER CONTROL METHOD AND POWER CONTROL SYSTEM FOR DYNAMICALLY ADJUSTING A POWER TABLE AND REDUCING POWER CONSUMPTION

(71) Applicant: MEDIATEK INC., Hsinchu City (TW)

(72) Inventors: Meng-Ju Hsieh, Hsinchu City (TW); Chien-Hao Chiang, Hsinchu City (TW); Hung-Lin Chou, Hsinchu City (TW)

(73) Assignee: MEDIATEK INC., Hsinchu City (TW)

(21) Appl. No.: 18/953,119

(22) Filed: Nov. 20, 2024

(51) Int. Cl. G06F 1/3234; G06F 9/30; G06F 17/40

(52) U.S. Cl. CPC G06F 1/3234; G06F 9/30083; G06F 17/40

(57) ABSTRACT

A power control method can include dynamically collecting data of a plurality of first indices of a processing device when the processing device is operated at runtime, wherein the first plurality of indices are selected from a power table representing operation capacity of the processing device; generating a first adjustment value according to a difference between data of the power table and the collected data of the plurality of first indices; and updating the power table for the processing device according to the first adjustment value.

### BACKGROUND

In the realm of computers, circuits, and electronic products, power management plays a pivotal role. If the supplied power is too high, it can lead to excessive energy consumption. Conversely, insufficient power may render the device operation unstable, causing unwanted pauses and a significant performance drop.

To achieve effective power control, a power and capability table (also known as a power table) is commonly employed. This table defines appropriate power levels corresponding to different computing capabilities. However, the conventional approach involves executing predefined benchmarks, observing various computing scenarios, and noting the corresponding power consumption. Based on these observations, a power table is generated.

Yet, when the device operates in real-world scenarios, relying solely on the predetermined power table often falls short of optimizing power management. As a consequence, power-saving efforts suffer, and overall operational performance may be compromised.

### SUMMARY

An embodiment provides a power control method including dynamically collecting data of a plurality of first indices of a processing device when the processing device is operated at runtime, wherein the first plurality of indices are selected from a power table representing operation capacity of the processing device; generating a first adjustment value according to a difference between data of the power table and the collected data of the plurality of first indices; and updating the power table for the processing device according to the first adjustment value.

Another embodiment provides a power control system for a processing device. The power control system includes a collector configured to dynamically collect data of a plurality of first indices of the processing device when the device is operated at runtime, wherein the first plurality of indices are selected from a power table representing operation capacity of the processing device; a calculator configured to generating a first adjustment value according to a difference between data of the power table and the collected data of the plurality of first indices; and an adjuster configured to update the power table for the processing device according to the first adjustment value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a power control system for a processing device according to an embodiment.

FIG. 2 illustrates an exemplary two-dimensional graph corresponding to the power table in FIG. 1.

FIG. 3 illustrates the power control system for the processing device in another condition.

FIG. 4 illustrates a flowchart of a power control method for the power control system in FIG. 1.

FIG. 5 illustrates a flowchart of a power control method for the power control system in FIG. 3.

### DETAILED DESCRIPTION

In the text, the conjunction “and/or” when used to connect multiple items within a phrase, signifies that each item, individually or in any possible combination with other items, may be applicable.

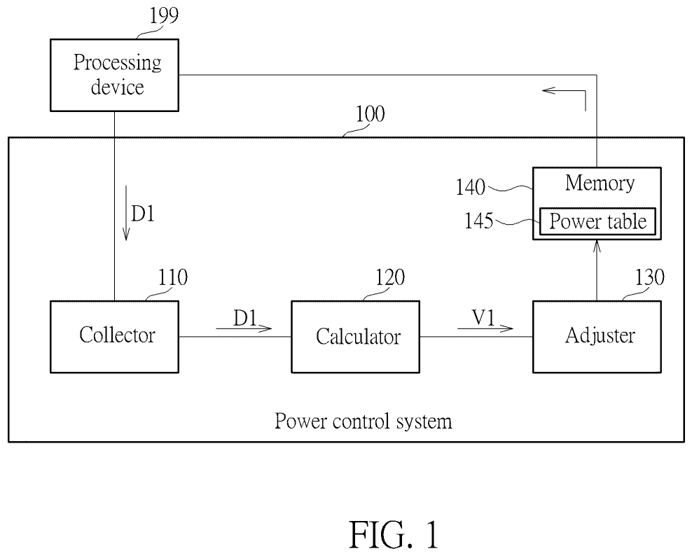

FIG. 1 illustrates a power control system 100 used for a processing device 199 according to an embodiment. The power control system 100 can include a collector 110, a calculator 120 and an adjuster 130.

The collector 110 can be linked to the processing device 199 and used to dynamically collect data of a plurality of first indices D1 of the processing device 199 when the processing device 199 is operated at runtime. The first plurality of indices D1 can be selected from a power table 145 representing operation capacity of the processing device 199.

The calculator 120 can generate a first adjustment value V1 according to a difference between data of the power table 145 and the collected data of the first indices D1.

The adjuster 130 can update the power table 145 for the processing device 199 according to the first adjustment value V1. The power table 145 for the processing device 199 can record a relationship between power supplied to the processing device 199 and operation capacity of the processing device 199. The power table 145 can be stored in a memory 140. The memory 140 can be embedded in the power control system 100 or disposed outside the power control system 100.

The processing device 199 can include a processor and/or a memory. For example, the processing device 199 can include a CPU (central processing unit), a GPU (graphic processing unit), a TPU (tensor processing unit), an NPU (neural network processing unit), a DPU (deep-learning processing unit), a microprocessor, a microcontroller and/or a DRAM (dynamic random access memory).

The power table 145 can be updated when the difference between the data of the power table 145 and the collected data of the plurality of first indices D1 exceeds a predetermined threshold.

The abovementioned runtime may refer to real scenarios that include playing games, playing videos, streaming on-line videos, running simulation programs, performing academic and engineering calculations, etc.

The first indices D1 of the processing device 199 can include a power index, an operation score, a cycle time, the number of instructions, a stall ratio and/or a latency. When the power index is elevated, it is related to increased power consumption. Consequently, additional power becomes necessary. When the operation score falls below a desired threshold, it needs an increase in power supplied to the processing device 199. Prolonged cycle lengths impact the operation clock of processing device 199, resulting in slower execution. To mitigate this, applying additional power can help maintain desired clock speeds and overall responsiveness. When the number of instructions processed grows, so does the demand for power, ensuring an adequate power supply facilitates seamless execution of complex instructions. A high stall ratio signifies frequent stalls experienced by processing device 199 during operation. To address this, supplementary power is essential to reduce latencies and enhance overall system fluency.

Hence, the power table 145 can be updated according to the first adjustment value V1 generated based on the first indices D1. The updated power table 145 can be used to control and apply power to the processing device 199. The difference between the original information in the power table 145 and the real information measured by monitoring the processing device 199 in real scenarios can be considered for updating the power table 145. In some embodiments, in order to avoid updating the power table 145 too frequently, the power table 145 is only updated when the difference exceeds a predetermined threshold.

The power table 145 for the processing device 199 can describe the relationship between the power supplied to the processing device 199 and the operation capacity of the processing device 199. Below, Table-1 provides an example of a power table of a processor. In this example, the processor can be in the processing device 199 in FIG. 1, and the processor can include a big core and a little core. The big core can be a high-performance core used for processing tasks that require more computational power, such as gaming, video editing, or other high-performance applications. Because the big core needs to provide high performance, the big core usually consumes more power. The little core can be a lower-performance but more power-efficient core used for processing tasks that require lower computational power, such as basic system operations, background tasks, or other low-performance applications.

TABLE 1

| | |
|---|---|
| Little core of the processor | Big core of the processor |

| Operation capacity | Power | Operation capacity | Power |
|---|---|---|---|
| 170 | 50 | 512 | 400 |
| 341 | 150 | 768 | 800 |
| 512 | 300 | 1024 | 1700 |

Table-1 is merely an example for explaining the content of a power table, but the power table 145 for the processing device 199 is not limited to Table-1.

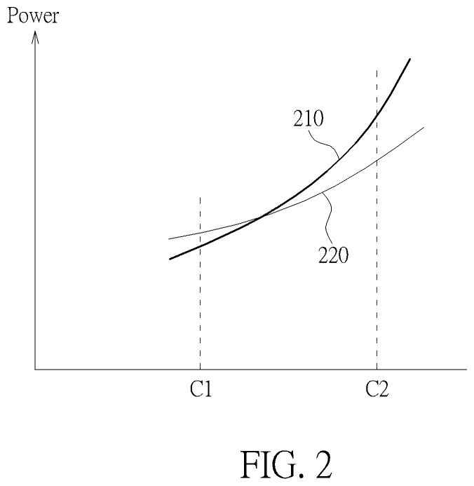

FIG. 2 illustrates an exemplary two-dimensional graph corresponding to the power table 145 of FIG. 1. The horizontal axis represents the operation capacity of the processing device 199, and the vertical axis represents the power supplied to the processing device 199. The operation capacity in FIG. 2 can be corresponding to the computing capacity, operation frequencies and/or performance of the processing device 199. In FIG. 2, the operation capacity of the processing device 199 can be measured in terms of megahertz (MHz) or gigahertz (GHz), and the power supplied to the processing device 199 can be measured in watts.

When the processing device 199 is operated with a higher operation capacity, the power supplied to the processing device 199 rises accordingly. A curve 210 can be related to an original power table of the processing device 199, and a curve 220 can be related to an updated power table of the processing device 199.

In the example of FIG. 2, after the power table 145 is updated, for the operation capacity C1, more power will be supplied to the processing device 199 according to the updated power table 145 to make the processing device 199 operate more smoothly. After the power table 145 is updated, for the operation capacity C2, less power will be supplied to the processing device 199 according to the updated power table 145 to save more power while maintaining smooth operation.

FIG. 2 is an example to describe the adjustment of a two-dimensional graph related to a power table, and embodiments are not limited thereto.

As depicted in FIG. 1 and FIG. 2, during the operation of the processing device 199 in real scenarios (such as gaming, video editing, streaming video display, etc.), the power table 145 can be dynamically updated based on the first indices D1, which are derived from the real-time monitoring of the processing device 199. The power supplied to the processing device 199 can be adjusted in real time according to the updated power table 145. Subsequently, the updated first indexed D1 can be collected to further update to the power table 145. The power control system 100 allows for the real-time update of the power table 145, thereby optimizing power supplied to the processing device 199. It also ensures that the power-saving effect is not constrained by a singular and inaccurate power table.

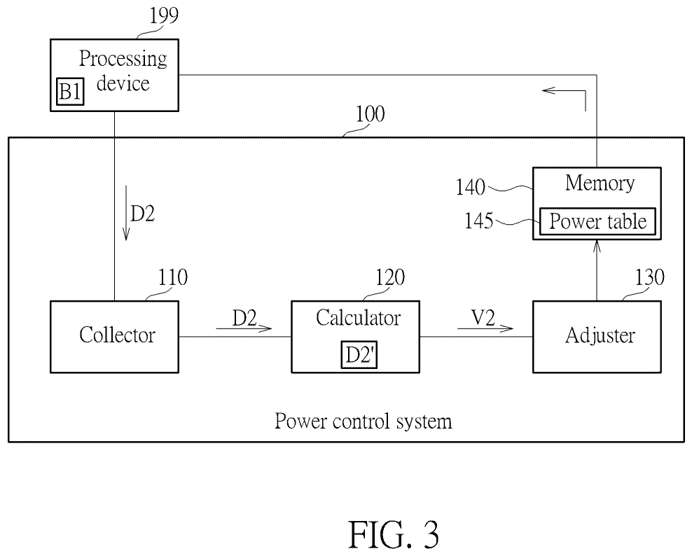

FIG. 3 illustrates the power control system 100 used for the processing device 199 in another condition. As shown in FIG. 3, the collector 110 can further collect a plurality of second indices D2 when the processing device 199 executes a specific benchmark B1. For example, when the processing device 199 is not operated in real scenarios, the processing device 199 can execute the specific benchmark B1 for the collector 110 to collect the second indices D2. In the text, when the processing device 199 is not operated in real scenarios, the processing device 199 can be considered “offline”. Hence, the second indices D2 can be measured and collected offline. Similar to the first indices D1, the second indices D2 of the processing device 199 can include a power index, an operation score, a cycle time, number of instructions, a stall ratio and/or a latency.

The calculator 120 can further generate correlations between the second indices D2 and power consumption of the processing device 199, select a subset of second indices D2′ from the plurality of second indices D2 according to the correlations, and generate a second adjustment value V2 according to the selected subset of second indices D2′. The correlations between the second indices D2 and power consumption of the processing device 199 can be generated using linear regression. The selected subset of second indices D2′ are the first few indices of the second indices D2 that are most relevant to the power consumption of the processing device 199, such as the top three relevant indices or the top two relevant indices of the second indices D2. The adjuster 130 can further update the power table 145 for the processing device 199 according to the second adjustment value V2 generated based on the selected subset of second indices D2′. By selecting the subset of second indices D2′ that are most relevant to power consumption and updating the power table 145 accordingly, the accuracy of updating the power table can be improved, and the power saving effect can be also enhanced.

Optionally, the list of selected subset of second indices D2′ can be stored. Subsequently, when the processing device 199 is operated in real scenarios, the collector 110 can retrieve indices based on this stored list to update the power table 145 accordingly, thereby avoiding the need to utilize and process a wider range of indices.

Optionally, initial data of the power table 145 can be null, and the collected data of the plurality of first indices D1 can become the initial data of the power table 145. In other words, the default data for the power table 145 can be null. Subsequently, appropriate data can be generated and updated according to the first indices D1 and/or the second indices D2, and the generated data can be filled in the power table 145 for controlling power.

The collector 110, the calculator 120, and the adjuster 130 can be implemented using appropriate hardware, software, and/or firmware. In FIG. 1 and FIG. 3, the collector 110, the calculator 120, and the adjuster 130 can be implemented with an integrated circuit. The collector 110, the calculator 120, and the adjuster 130 can be integrated with the same hardware module and/or software module. In another embodiment, the collector 110, the calculator 120, and the adjuster 130 can be separated with separated hardware modules and/or software modules. For instance, the collector 110, the calculator 120, and the adjuster 130 could be designed using a hardware description language (HDL) in a netlist file and subsequently synthesized for physical implementation. Optionally, each of the collector 110, the calculator 120 and the adjuster 130 can include a neural network and/or a machine learning model to enhance the precision of operations over a period of time.

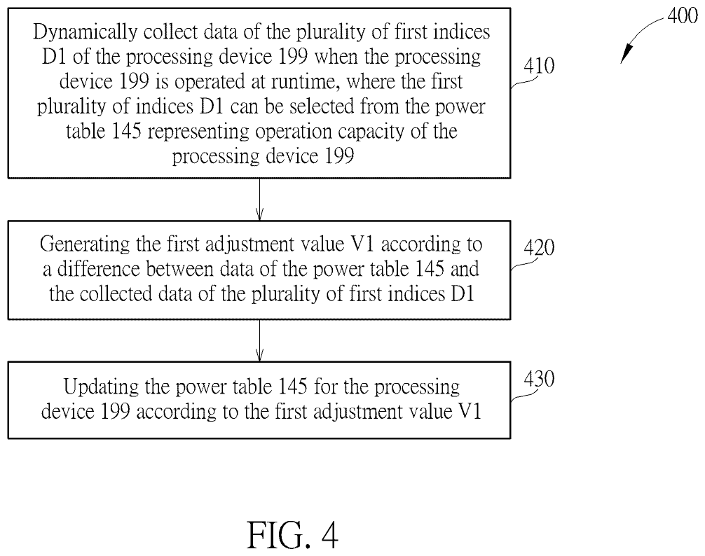

FIG. 4 illustrates a flowchart of a power control method 400 for the power control system 100 in FIG. 1. As shown in FIG. 1 and FIG. 4, the power control method 400 can include the following steps.

Step 410: dynamically collect data of the plurality of first indices D1 of the processing device 199 when the processing device 199 is operated at runtime, where the first plurality of indices D1 can be selected from the power table 145 representing operation capacity of the processing device 199;

Step 420: generating the first adjustment value V1 according to a difference between data of the power table 145 and the collected data of the plurality of first indices D1; and

Step 430: updating the power table 145 for the processing device 199 according to the first adjustment value V1.

Step 410 can be performed with the collector 110. Step 420 can be performed with the calculator 120. Step 430 can be performed with the adjuster 130.

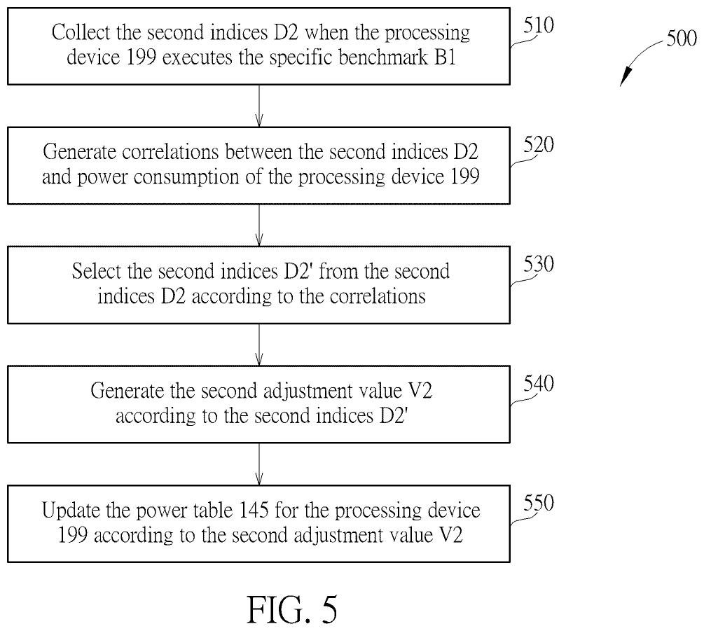

FIG. 5 illustrates a flowchart of a power control method 500 for the power control system 100 in FIG. 3. As shown in FIG. 3 and FIG. 5, the power control method 500 can include the following steps.

Step 510: collect the second indices D2 when the processing device 199 executes the specific benchmark B1;

Step 520: generate correlations between the second indices D2 and power consumption of the processing device 199;

Step 530: select the second indices D2′ from the second indices D2 according to the correlations;

Step 540: generate the second adjustment value V2 according to the second indices D2′; and

Step 550: update the power table 145 for the processing device 199 according to the second adjustment value V2.

Step 510 can be performed with the collector 110. In Step 510, the processing device 199 does not need to be operated in real scenarios. Step 520 to Step 540 can be performed with the calculator 120. Step 550 can be performed with the adjuster 130.

In Step 540 and Step 550, the second adjustment value V2 can be generated according to the updated second indices D2′, where the updated second indices D2′ can be collected in real scenarios of the processing device 199. The flow in FIG. 5 can serve as a supplementary alternative to the flow in FIG. 3.

In FIG. 1 and FIG. 4, the data in the power table 145 can be dynamically generated, corrected and updated in real time according to the first indices D1 collected in real scenarios. In FIG. 3 and FIG. 5, the specific benchmark B1 can be executed for generating the second indices D2′ to subsequently update the power table 145 according to statistical results. Optionally, several iterations of the power table 145 can be preserved for scenarios that resemble past scenarios, or for analysis to enhance the efficacy of the power control. As a result, the efficacy of power conservation is effectively enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power control method comprising:
dynamically collecting data of a plurality of first indices of a processing device when the processing device is operated at runtime, wherein the first plurality of indices are selected from a power table representing operation capacity of the processing device;
generating a first adjustment value according to a difference between data of the power table and the collected data of the plurality of first indices; and
updating the power table for the processing device according to the first adjustment value.

2. The power control method of claim 1, wherein the operation capacity of the processing device corresponds to operation frequencies of the processing device.

3. The power control method of claim 1, wherein the plurality of first indices of the processing device comprise a power index, an operation score, a cycle time, number of instructions, a stall ratio and/or a latency.

4. The power control method of claim 1, further comprising:
collecting a plurality of second indices when the processing device executes a specific benchmark;
generating correlations between the plurality of second indices and power consumption of the processing device;
selecting a subset of second indices from the plurality of second indices according to the correlations;
generating a second adjustment value according to the subset of second indices; and
updating the power table for the processing device according to the second adjustment value.

5. The power control method of claim 4, wherein the plurality of second indices of the processing device comprise a power index, an operation score, a cycle time, number of instructions, a stall ratio and/or a latency.

6. The power control method of claim 4, wherein the correlations are generated using linear regression.

7. The power control method of claim 1, wherein the power table is updated when the difference between the data of the power table and the collected data of the plurality of first indices exceeds a predetermined threshold.

8. The power control method of claim 1, wherein initial data of the power table is null, and the collected data of the plurality of first indices become the initial data of the power table.

9. A power control system for a processing device, comprising:
a collector configured to dynamically collect data of a plurality of first indices of the processing device when the device is operated at runtime, wherein the first plurality of indices are selected from a power table representing operation capacity of the processing device;
a calculator configured to generating a first adjustment value according to a difference between data of the power table and the collected data of the plurality of first indices; and
an adjuster configured to update the power table for the processing device according to the first adjustment value.

10. The power control system of claim 9, wherein:
the collector is further configured to collect a plurality of second indices when the processing device executes a specific benchmark;
the calculator is further configured to generate correlations between the plurality of second indices and power consumption of the processing device, select a subset of second indices from the plurality of second indices according to the correlations, and generate a second adjustment value according to the subset of second indices; and
the adjuster is further configured to update the power table for the processing device according to the second adjustment value.

11. The power control system of claim 9, wherein the collector, the calculator and the adjuster are implemented with an integrated circuit.
